(19) United States
(12) Patent Application Publication
(10) Pub. No.: US 2002/0099834 A1
(43) Pub. Date: Jul. 25, 2002

(54) Rules-based decision engine

(75) Inventors: Martin Sielaff, Chandler, AZ (US); Michael J. Noe, Scottsdale, AZ (US)

Correspondence Address: MORGAN LEWIS & BOCKIUS LLP, 1111 PENNSYLVANIA AVENUE NW, WASHINGTON, DC, 20004, US

(73) Assignee: NeoPlanet, Inc.

(21) Appl. No.: 09/922,709

(22) Filed: Aug. 7, 2001

Related U.S. Application Data
(60) Provisional application No. 60/263,089, filed on Jan. 19, 2001.

(51) Int. Cl. G06F 15/173; G06F 15/16

(52) U.S. Cl. 709/228; 709/225; 709/219

(57) ABSTRACT

The present invention relates to a rules evaluation system for a user's computer comprising a rules-based agent having a plurality of rule clauses for evaluating data; a plurality of triggers having functionality to notify the rules-based agent to begin evaluating; a plurality of data providers to provide data for evaluation; and a plurality of actions for providing information to a user based upon the evaluated data.

This application claims priority to provisional patent application Serial No. 60/263,089, filed on Jan. 19, 2001.

### FIELD OF THE INVENTION

The present invention relates to a system for providing information to a computer user in both a client/server environment and to a computer user alone, using a rules engine application program. The rules engine application program may reside on either the client or server system, and is capable of forwarding information to a user while maintaining the user's privacy.

### BACKGROUND OF THE INVENTION

Advances in computer processing power and network communications have made information from a wide variety of sources available to users on computer networks. Computer networking allows network computer users to share information, software applications and hardware devices, and internetworking enables a set of physical networks to be connected into a single network such as the Internet. Computers connected to the Internet or connected to networks other than the Internet also have access to information stored on those networks. The World Wide Web (Web), a hypermedia system used on the Internet, enables hypertext linking, whereby documents automatically reference or link other documents located on connected computer networks around the world. Thus, users connected to the Internet have almost instant access to information stored in relatively distant regions.

A page of information on the Web may include references to other Web pages and may include a broad range of multimedia data including textual, graphical, audio, and animation information. Currently, Internet users retrieve information from the Internet, through the Web, by ‘visiting’ a web site on a computer that is connected to the Internet.

The web site is, in general terms, a server application that displays information stored on a network server computer. The web site accepts connections from client programs, such as Internet browser applications. Browser applications, such as Microsoft Explorer™ or Netscape Internet Browser™, allow Internet users to access information displayed on the web site. Most browser applications display information on computer screens and permit a user to navigate through the Web using a mouse. Like other network applications, Web browsing uses a client-server paradigm. When given a Uniform Resource Locator (URL) of a document, the browser application becomes a client and it contacts a server application specified in the URL to request the document. After receiving the document from the server application, the browser application displays the document to the user. When the browser application interacts with the server application, the two applications follow the Hyper-Text Transport Protocol (HTTP). HTTP allows the browser application to request a specific article, which the server application then returns. To ensure that browser applications and server applications inter-operate unambiguously, HTTP defines the exact format for requests sent from the browser application to the server application as well as the format of replies that the server application returns.

As the number of physical networks connected to the Internet continues to grow, so too will the number of web sites that are accessible to Internet users and so too will commercial activity on the Internet. Providers of a wide range of products and/or services are continuously exploring new methods for promoting and selling them. Commercial vendors' web sites are similar to other types of web sites except that they usually incorporate functionality to enable financial transactions between users and vendors.

With the increase in Internet use has come the increase in of online advertisements, online information dissemination, and user security concerns. Online advertisements are of a number of forms, including banner ads displayed across a user's screen or animated ads displayed in a special box or in a pop-up box on the screen. Usually, these types of ads are shown randomly or in a sequential order to all online users.

Advertisers generally prefer, however, to show specific ads to specific demographic groups. One way to achieve this type of target advertising has been to have the client computer send information about the user (such as age, gender, occupation, household income, etc) to a server computer and then filter through which ads to provide at the servers. This places a huge burden on a server. Moreover, many users simply do not want to share their personal identifying information over the Internet.

What is needed, therefore, is a way to select demographically correct ads in an efficient and secure manner that does not tax either the client or server.

### SUMMARY OF THE INVENTION

Accordingly, the present invention is directed to a system for providing information to a computer user in a client/server environment using a rules engine application program that substantially obviates one or more of the problems due to limitations and disadvantages of the related art.

An object of the present invention is to provide a system that monitors a user's computer and forwards information to the user at appropriate times.

Another object of the present invention is to provide a system that allows users to receive information while maintaining security of user identification.

Another object of the present invention is to provide a dynamically updateable information system.

Additional features and advantages of the invention will be set forth in the description that follows, and in part will be apparent from the description, or may be learned by practice of the invention. The objectives and advantages of the invention will be realized and attained by the system particularly pointed out in the written description and claims hereof as well as the appended drawings.

To achieve these and other advantages and in accordance with the purpose of the invention, as embodied and broadly described, the present invention provides a system for providing information to a client computer in a client/server environment comprising a client computer coupled to a server computer, the client computer operable to send demographical information to a server computer and receive a package of rule files from the server computer based on the demographical information, the client computer further operable to select one or more rule files from the package using a rules engine and based on rules clauses-included with the rule files.

An alternate embodiment of the present invention provides a method for providing information to a computer in a client/server environment comprising sending demographic information to a server computer; receiving a package of rule files from a server computer, the choice of package received determined in part by the demographic information; and choosing rule files from the package at the client by using a rules-based comparison of demographic information with rules clauses included in the rule files.

An alternate embodiment of the present invention provides a computer-readable medium having computer-executable instructions for performing steps comprising receiving demographic information; comparing the demographic information received to demographic values stored in one or more rules clauses stored in one or more files stored in a package of files; selecting files from the package based on the comparison; and executing actions associated with the selected files.

In yet another embodiment, the present invention provides a data structure for a decision engine stored in a computer readable medium, the data structure comprising first section for storing actions to be performed; and second section containing one or more rules clauses to be executed by the decision engine, the execution of the actions in the first section depending on the evaluation of the rules clauses.

In yet another embodiment, the present invention provides a rules evaluation system for a user's computer comprising a rules-based agent having a plurality of rule clauses for evaluating data; a plurality of triggers having functionality to notify the rules-based agent to begin evaluating a plurality of data providers to provide data for evaluation; and a plurality of actions for providing information to a user based upon the evaluated data.

In yet another embodiment, the present invention provides a rules evaluation system comprising a rules engine; one or more rules clauses for processing by the rules engine, each rules clause having a specific type, a comparison statement and a value; a grammar file for processing by the rules engine, the grammar file providing an interpretation of comparison statements found in the rules clause; one or more items of user data for processing by the rules engine, the user data containing demographical information concerning a user, the user data to be compared with values stored in the rules clauses by the rules engine; and wherein the rules engine evaluates the rules clauses using the user data and grammar file, the rules engine executing an action if the rules clauses are evaluated to be true.

### BRIEF DESCRIPTION OF THE DRAWINGS

The accompanying drawings, which are included to provide a further understanding of the invention and are incorporated in and constitute a part of this specification, illustrate embodiments of the invention that together with the description serve to explain the principles of the invention.

In the drawings:

FIG. 1 illustrates a computer network in which the inventive rules-based decision engine may be incorporated;

FIG. 2 illustrates the TCP/IP Layering Model Protocol used during communications between components on the computer network;

FIG. 3 illustrates a rules engine according to one embodiment of the present invention;

FIGS. 4A and 4B illustrate a data structure used with the rules engine of FIG. 3;

FIG. 5 is a flowchart illustrating the operation of the embodiment of FIG. 3;

FIG. 6 is a block diagram of another embodiment of the inventive rules-based decision engine; and

FIG. 7 illustrates the details of each of the blocks of FIG. 6.

### DESCRIPTION OF THE PREFERRED EMBODIMENTS

Reference will now be made in detail to the preferred embodiments of the present invention, examples of which are illustrated in the accompanying drawings. The present invention described below describes the functionality of the inventive system for providing information to a computer user in a client/server environment using a rules engine application program.

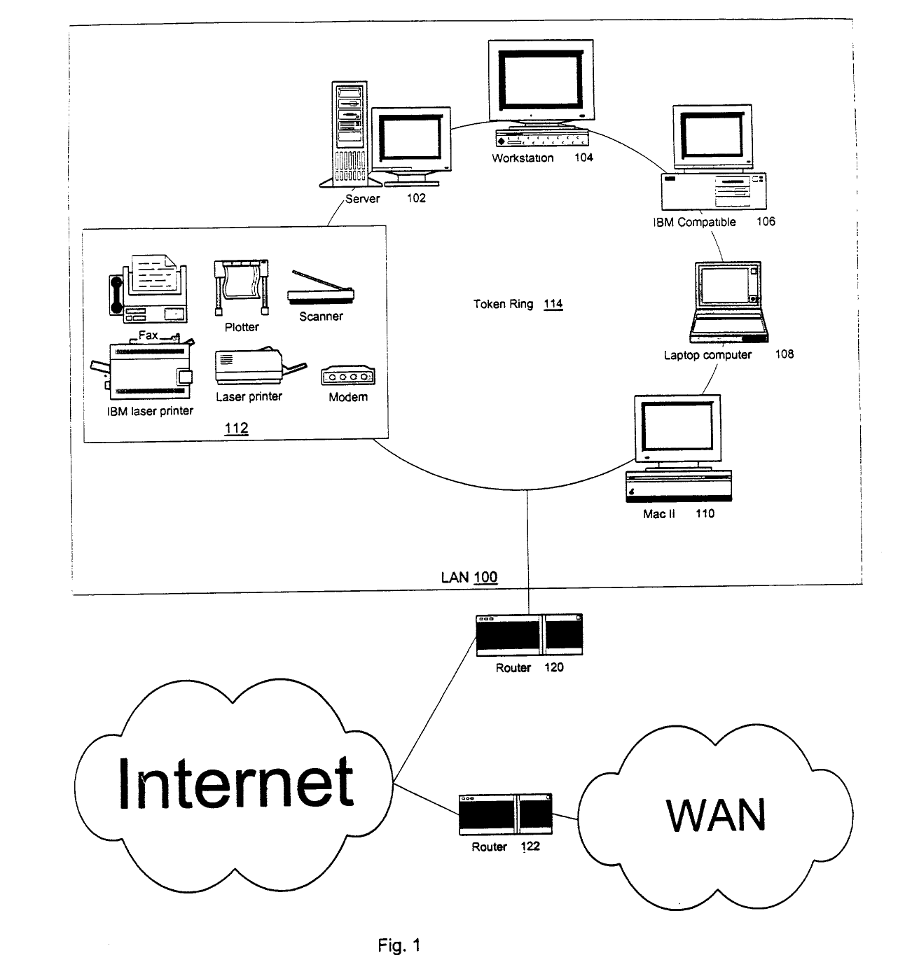

FIG. 1 is an example of a local area network (LAN) 100 that is configured to utilize a non-repudiation protocol. LAN 100 comprises a server 102, four computer systems 104, 106, 108, and 110, and peripherals 112, such as printers and other devices that may be shared by components on LAN 100. Computer systems 104, 106, 108 and 110 may serve as clients for server 102 and/or as clients and/or servers for each other and/or for other components connected to LAN 100. Components on LAN 100 are preferably connected together by cable media, for example copper or fiber-optic cable and the network topology may be a token ring topology 114. It should be apparent to those of ordinary skill in the art that other media, for example, wireless media, such as optical and radio frequency, may also connect LAN 100 components. It should also be apparent that other network topologies, such as Ethernet, may be used.

Data may be transferred between components on LAN 100 in packets, i.e., blocks of data that are individually transmitted over LAN 100. Routers 120, 122 create an expanded network by connecting LAN 100 to other computer networks, such as the Internet, other LANs or Wide Area Networks (WAN). Routers are hardware devices that may include a conventional processor, memory, and separate I/O interface for each network to which it connects. Hence, components on the expanded network may share information and services with each other. In order for communications to occur between components of physically connected networks, all components on the expanded network and the routers that connect them must adhere to a standard protocol. Computer networks connected to the Internet and to other networks typically use TCP/IP Layering Model Protocol. It should be noted that other internetworking protocols may be used.

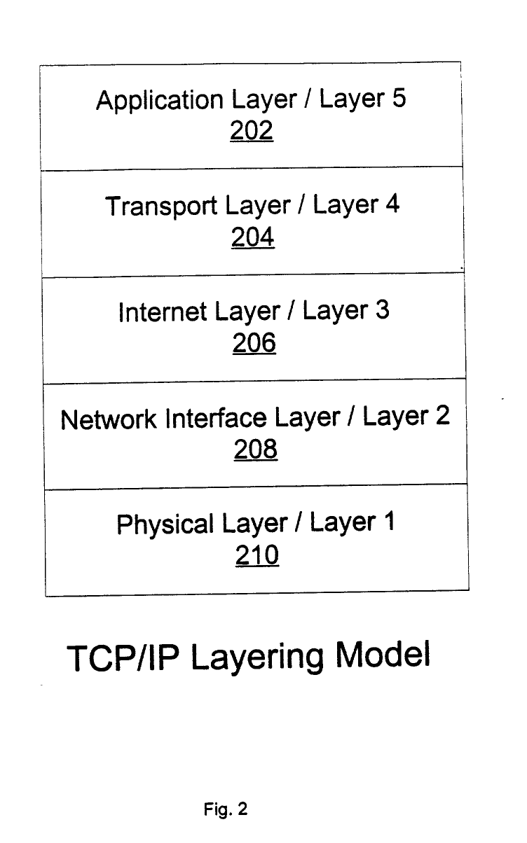

As illustrated in FIG. 2, the TCP/IP Layering Model comprises an application layer (Layer 5) 202, a transport layer (Layer 4) 204, an Internet layer (Layer 3) 206, a network interface layer (Layer 2) 208, and a physical layer (Layer 1) 210. Application layer protocols 202 specify how each software application connected to the network uses the network. Transport layer protocols 204 specify how to ensure reliable transfer among complex protocols. Internet layer protocols 206 specify the format of packets sent across the network as well as mechanisms used to forward packets from a computer through one or more routers to a final destination. Network interface layer protocols 208 specify how to organize data into frames and how a computer transmits frames over the network. Physical layer protocols 210 correspond to the basic network hardware. By using TCP/IP Layering model protocols, any component connected to the network can communicate with any other component connected directly or indirectly to one of the attached networks.

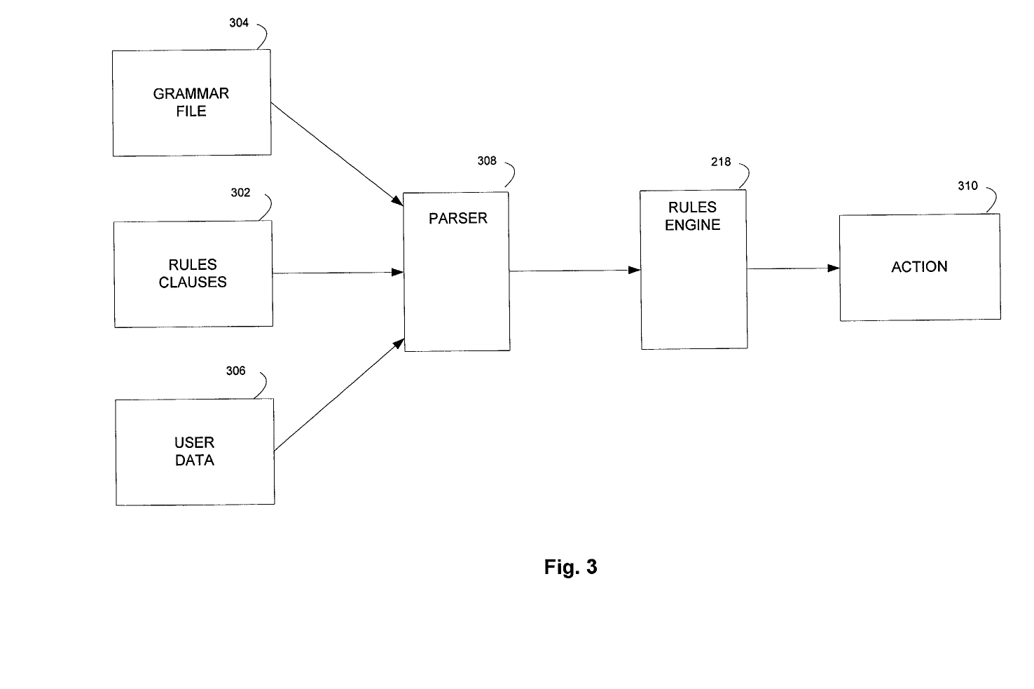

FIG. 3 is a block diagram illustrating an embodiment of the inventive rules engine. Client rules engine 218 receives three inputs: user data 306, rules clauses 302 and grammar file 304. A parser 308 may be placed between the inputs and the rules engine to extract information from user data 306, rules clause 302, and grammar file 304 and place it in a form useable by client rules engine 218. For example, if the inputs are found in a file written in extensible markup language (XML), an XML parser would be used to extract the user data 306, rules clauses 302 and grammar files 304 from a rule file and into a form usable by client rules engine 218.

Rule clauses 302 are statements that are associated with actions that are then compared to demographic data by client rules engine 218 to determine if the associated action will be performed. In one embodiment, rules clause 302 takes the form:

Type:<R/0>:comparison statement: value

Type indicates a demographical information type such as age of the user, gender of the user, hard drive size of the computer, etc. User data or demographical information is any information regarding a user, the user's computer or how a user utilizes the computer.

R/O stands for required or optional. Each rule clause is either a required rule clause or an optional rule clause. Required rules operate like a Boolean AND function and optional rules operate as an OR function. For example, if a specific action has three required rules clauses associated with, all three rules clauses must be true in order for the action to be taken. If a specific action has three required rules clauses and two optional rules clauses all three required rules clauses, and at least one of the two optional rules clauses must be true in order for the action to be taken.

Comparison statements are used to evaluate the rules clauses 302. These statements are used by the rules engine 218 to compare the value in the rule against the demographical data. The comparison statements are defined in grammar file 304 as discussed below.

Values in the above rules clause correspond to the values associated with the type in the rule clauses that are compared to demographical information provided by the user. Values can be string values (alphanumeric) or numerical values.

Grammar files 304 define the comparison statements and associates the comparison statements with a specific, type. For example, grammar file 304 might define the comparison state >= as an integer equal to or greater than and associate it with a demographical type, such as age. The following is an example of an exemplary grammar file:

Type 1

integer equality

not equal to

starts with

Type 2

string equality

string not equal to

In the above example, Type 1 may be a demographic type such as zip code. Then the comparison statement would compare the value in the rules clause with provided demographic data regarding the user's zip code to see if the numbers were equal. Type 2 could be the demographic type of the user's city and the comparison statement would evaluate whether the city listed in the rules clause 302 data section was not the same as the user's city.

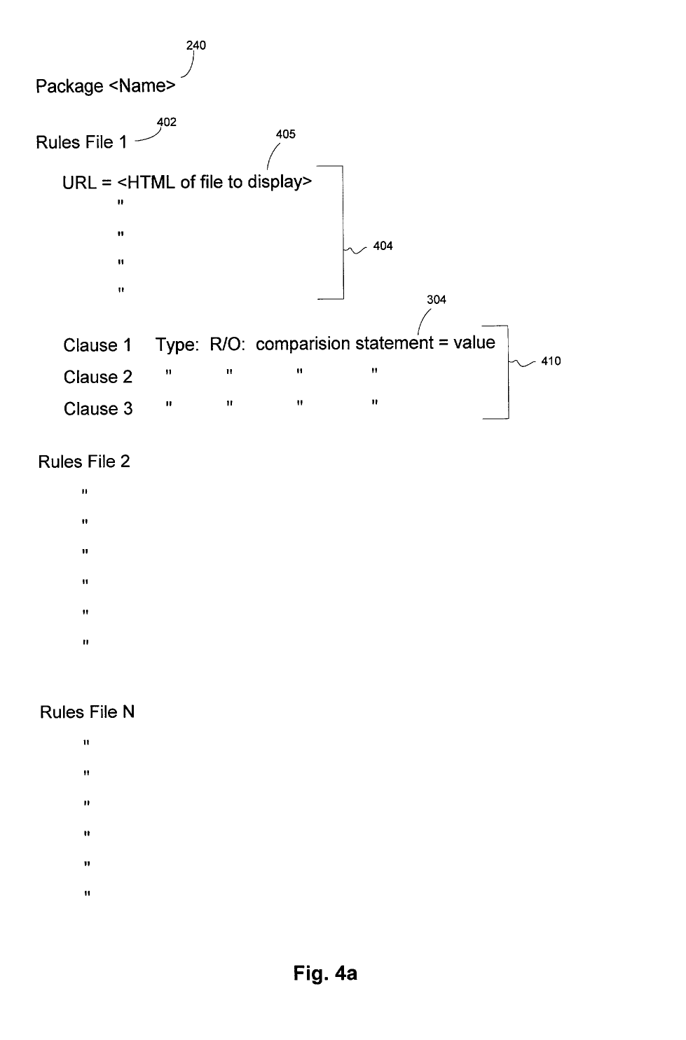

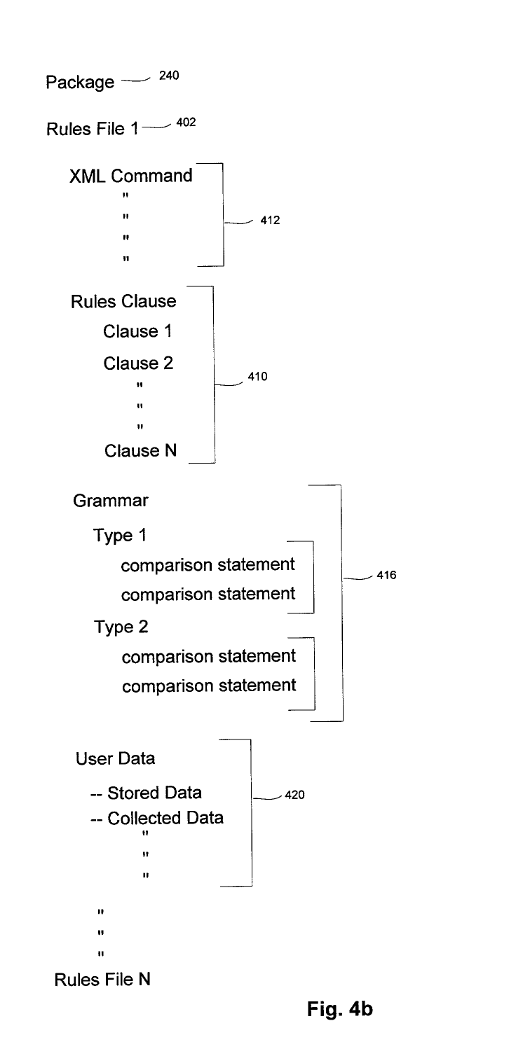

The grammar file 304 can be provided as a separate file, as a stand-alone dynamic link library in the Windows environment or as part of a rules file in a package 240 along with the rules clause 302. These options will be discussed further in conjunction with FIGS. 4a and 4b.

User data, as discussed previously, is any data regarding the computer, the user and how the computer is being used. In a most simple case, a web browser may maintain a file at the client computer of important user data. This information can then be sent to a remote server for use in a remote rules engine running on the remote server when the server engine is performing filtering steps. The file can also be used for the client rules engine.

In other embodiments, user data can be obtained from the user by use of a pop-up form or based on selections made by the user via a keyboard or mouse. Additionally, user data can be obtained via the running of a program that will collect information regarding the computer, user or the use of the computer. Also, a set of rules clauses may initiate an action that leads to the gathering of data for another set of rules clauses.

Client rules engine 218 takes the rules clauses 302 and user data 306 and, using the grammar file 304, evaluates the rules by performing a rules based comparison of the user data the value in a rules clause. The result is either a logical true or false result. As discussed previously, rules can be required rules or optional rules. A series of required rules behave like a series of logically ANDed statements while optional rules act like ORed statements. Once a series of rules clauses 302 evaluate out correctly, an action occurs.

Action engine 310 executes the action associated with the rules clauses 302. Each set of rules clauses 302 will have at least one set of actions associated with the rules clauses. When the combination of rules clauses evaluates true, the action can occur. In one example, if the rules clause is of the type AGE, the comparison statement is greater than or equal to and the value is 17, if the user is 18 the rule engine 218 would output a true value and the action statement, which might be to retrieve and show an ad for an R-rated movie, might be executed. Action engine 310 may be the same as the actions listed in the rules files that can execute automatically upon evaluation by client rules engine 218.

FIG. 4a illustrates one embodiment of a package 240 containing at least one rule file 402. Rule file 402 consists of two parts: an action section 404 and a rules clause section 410. In this embodiment, action section 404 may contain a URL 405 where a file to be run is located. If the rules clauses 304, in the rules clause section 410 evaluate as true then the web browser 216 sends the URL 405 to a remote server and the file then can be run or downloaded. In this embodiment, rules clauses 302 are provided as part of the rule files 402 in the package 240. Grammar file 304 and user data 306, as discussed previously, may be provided as a separate file or dynamic link library.

FIG. 4b illustrates a second embodiment of a package 240 with one or more rules files 402. Each rule file can contain four parts: an action section 412; a rules clauses section 410; a grammar section 416; and a data section 420. In this embodiment, action section 412 may be a URL of a file to be executed or downloaded. However, action section 412 may also be more robust in this embodiment. For example, action section 412 may include a script to run, a DOS command to execute, a program or any other action. In one embodiment, action section 412 is written in extensible markup language (XML). The rules clause section 410 is similar to that described in FIG. 4a.

Grammar section 416 in FIG. 4b contains the information that was previously provided in a separate grammar file 304. The advantage of including a grammar section in a rules file is that it allows for the use of new comparison statements without the need to replace a separate grammar file.

Data section 420 may include the location of where data is located or can be obtained, a script written in a language such as JAVA to extract demographic data, the location of a program to run in order to get data or any other way to extract data. In certain cases, the data can be provided to a file in a package by another rules file.

All of the sections may be written in an extensible language such as extensible markup language (XML). If this is done, parser 308 is an XML parser operable to extract the necessary rules clauses, grammar, and data for the rules engine.

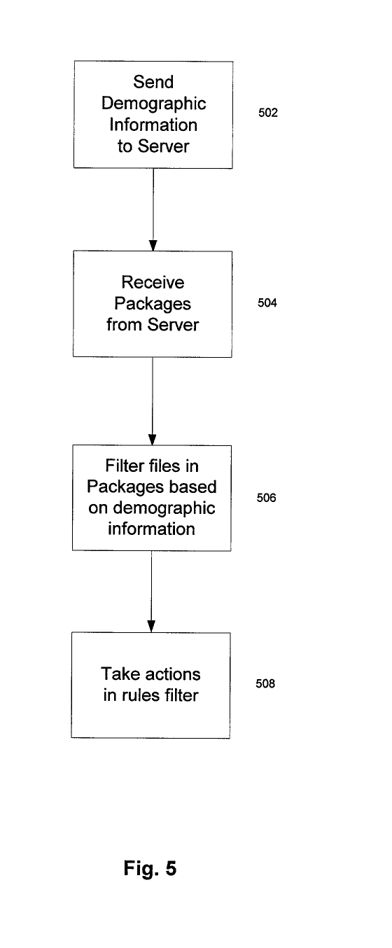

FIG. 5 is a flowchart illustrating the operation of the rules engine according to one embodiment of the present invention. In step 502, demographical information is provided from client to server. This is the typical case were filtering will be done at both the client and the remote server. In another embodiment, remote server may send down packages without any filtering at the remote server. The remote server performs filtering at the server side using remote rules engine. This determines which packages are to be sent to each client. For example, remote rules engine may evaluate a rules clauses that compares the user's zip code to a specific zip code. If the zip codes match, a certain package is sent to the client computer.

In step 504, the client receives packages from a remote server. In one embodiment, each package contains one or more rule files with each rules file containing an action section containing the location to download an advertisement and one or more rules clauses 302. Each rules clause 302 will be executed by the client rules engine 218 to determine if the advertisement is to be retrieved. In another embodiment, each package 240 may contain an action section 412 that lists one or more actions that will be executed if the associated rules clauses 302 evaluate to be true.

In step 506, the client rules engine 218 uses the rules clauses 302 (found in the rule files 402 of the package 240), the user data 306, and the grammar file 304 (if provided separately) to determine which rules files are to have the actions in their action section 412 performed. In certain cases, one or more rules may depend on an action that has yet to occur. For example, one of the rules clauses 302 for an advertising file might require the user to select a certain icon displayed on the screen. If this is the case, rules-engine 218, in conjunction with the web browser, will check for the selection of that icon and then fully execute the rules clause.

In step 508, the actions listed in the rules file 402 of the package 240 that evaluate to be true in the rules engine 218 are executed. That is, the correct advertisement is retrieved, the correct update is downloaded, the correct pieces of information is gathered, etc.

Thus a rules based decision engine has been disclosed that, in one embodiment, allows for filtering of information at both a server and a client in order to allow for the targeting of advertisements to specific users. This has the advantage of decreasing the total amount of information sent between a server and its clients by avoiding sending information to clients who have no need for the information.

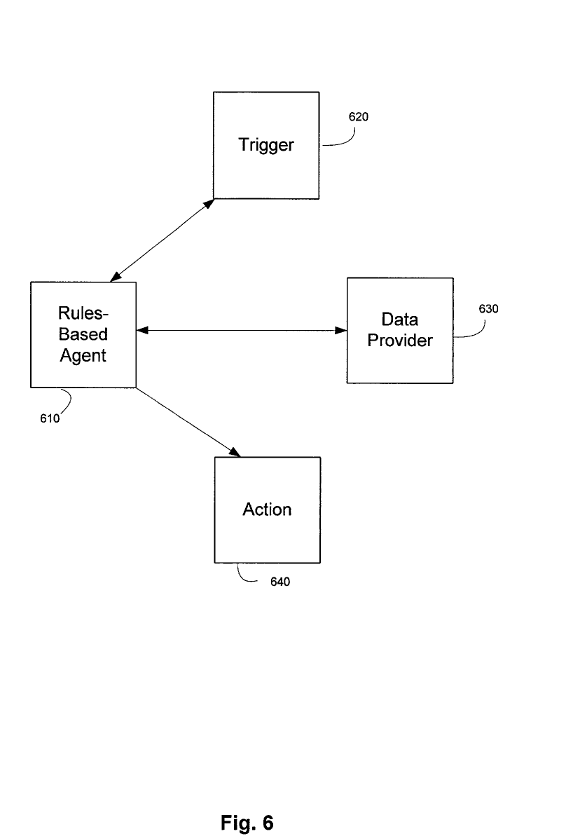

FIG. 6 is a block diagram of another embodiment of the present invention. According to this embodiment, any type of information can be disseminated to any type of user based upon any type of event. Moreover, this embodiment of the present invention is dynamically updateable and modular. As shown in FIG. 6, the present embodiment includes a rules-based agent 610, a trigger 620, a data provider 630, and an action 640.

The rules-based agent 610 contains rules clauses and may be written in extensible markup language (XML). The rules clauses are logic evaluator statements that can be associated with virtually any type of action. For example, the rule can evaluate the level of ink in an associated printer and can evaluate whether certain peripherals are connected to the client system. The rule also can evaluate actions taken in the client/server environments, such as when a large data file has been downloaded, and the computer may need more memory. The logic evaluation can be performed using any type of arithmetic equations. The rules-based agent contains a file that maps each unique data type in the system. Moreover, the user need not be registered with any outside entity to utilize the rules. On the other hand, the user may register with an outside entity and utilize different sets of rules that “communicate” with the outside world.

The trigger 620 can be simply a small piece of code that has basic functionality. The trigger can be based upon hardware presence, software presence, user behavior, time, and virtually anything that is detectable.

The data provider 630 is a small piece of code that can detect virtually anything and return a value, such as the level of ink in a printer, the speed of a hard drive, the amount of installed memory, etc.

Action 640 is code having the functionality to execute some action. Thus, if the rules-based agent evaluates the logic of the rule using data from the data provider and determines that an action is appropriate, a message is sent to action 640 to execute the action.

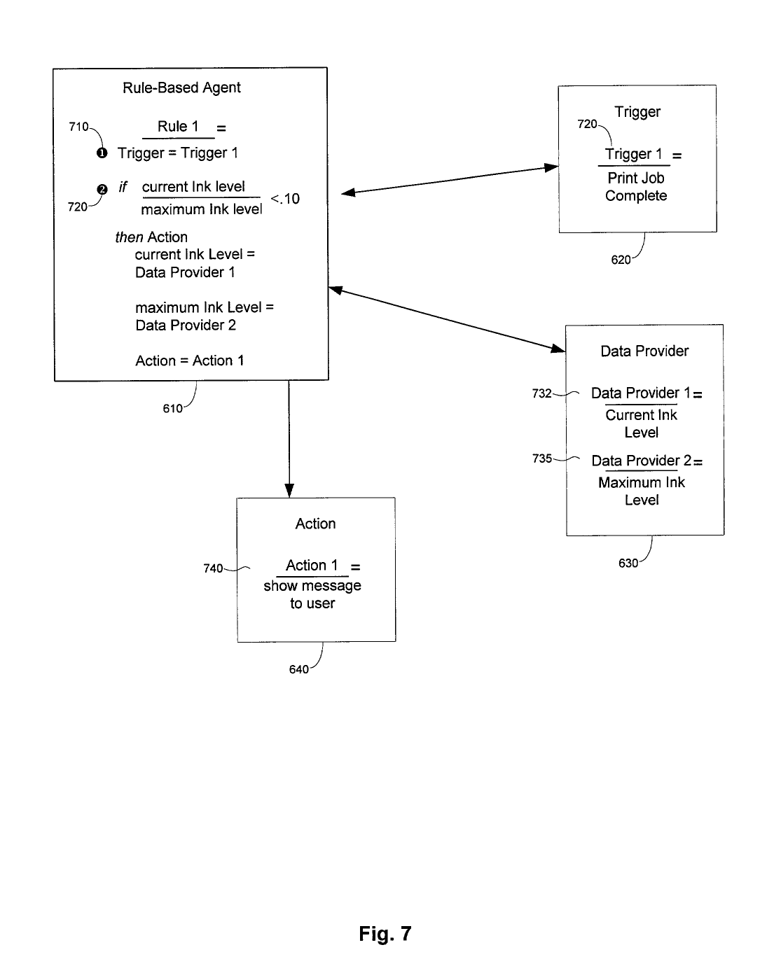

FIG. 7 illustrates how the embodiment of FIG. 6 processes data. The rules-based agent starts by loading Rule 1, shown as 710. Rule 1 begins with the clause Trigger=Trigger 1. The rules-based agent finds the piece of code corresponding to Trigger 1 in the system that meets this footprint, which is shown as 720. In this example, Trigger 1 is code that detects when a print job has been completed. Thus, when a user prints something, Trigger 1 sends a “fire” signal to the rules-based agent. The rules-based agent responds to this “fire” by proceeding to the second rules clause, which is an arithmetic evaluation to determine if the current ink level of the printer is lower than 10 percent of the maximum ink level. This clause contains two separate pieces of data that the rules-based agent needs from the data provider, shown as 730. Thus, the rules-based agent goes to data provider 1, shown as 732, which will read the ink level of the printer and supply the printer present ink level data to the rules-based agent. The rules-based agent then goes to data provider 2, shown as 735, which will find that general information of the system and supply the printer maximum ink level data to the rules-based engine. These data are sent to the rules-based agent, which then performs the arithmetic function by dividing the present ink level by the maximum level and comparing that result to 0.1. If the result is less than 0.1 (i.e., the ink level is less than 10 percent of the maximum), the rules-based engine sends a signal to Action 1, shown as 740. Action 1 has code that may communicate with a display agent within the system to display to the user a message, such as “Your printer is low on ink, click here for more information.”

If the user clicks as instructed, another Window may come up to instruct the user to order a new cartridge or wait until the ink cartridge is below 5%. If the user clicks on the wait instruction, another rule comes into play. This rule is very similar to the rule discussed above; however, the Action is signaled when the arithmetic evaluation results in the result of 0.05.

It is important to note that the user need not be registered with any outside entity to receive this message. If the user clicks on the instruction to order a cartridge, the system may at that point allow the user to communicate with the outside world. It may only be then that the user may supply credit card, address, and telephone information on-line and have an ink cartridge delivered. On the other hand, the user may simply use the information regarding the status of the printer to decide to actually buy a new ink cartridge at a bricks and mortar store.

Also important to note is that the trigger can be virtually anything. The trigger may be a new peripheral that is added to the system later, a particular date or time that the user is using the computer system, or certain functions or user actions. For example, a rule may trigger if a user uses the computer on battery for a certain amount of time, on average. The rule may call up an action that displays information to that user about a longer lasting battery.

The rules-decision engine, therefore, is dynamically updateable as new rules can be downloaded when a user is online, can be added to the user's computer using a disk or CD or when new software is installed. As new peripherals, software, and functions are created, a user can gain information relating to each.

Moreover, the rules-decision engine can function completely anonymously (such as the printer ink described above) or can function with users that register with outside entities. Even when a user submits personal data to outside entities, the rules-based decision engine may maintain user security with respect to the different rules-based agent, data providers, and triggers because the system is modular. For example, a company may have a proprietary software program that taps into a real time system and stores data on a user's computer while the user is online using the company's site. The company thus may develop data providers that can read its own proprietary data files and return simple numbers to the rules-based agent. The returned numbers are meaningless beyond the evaluation factor, however. Moreover, different triggers can be developed in a similar manner. For example, a trigger may monitor data from a user's real time activity. The trigger may be meaningless to the rules-based agent beyond the function of trigger. Therefore, different entities may create rules, triggers and actions to be used in a single system without having the user disclose all personal data to each entity.

The inventive system also can supply a user with full knowledge of the entire online world if the user is willing to register without restraints since triggers can be created for anything. Thus, a user may be reading about a new IRS regulation, and this information may be passed to a private banking institution that triggers to the estate group. The user may thus be contacted and asked if recent publications relating to the user's estate plan should be forwarded. Thus, it should be apparent to those skilled in the art that the scope of the rules-based decision engine is virtually limitless. The inventive system allows a user to receive any type of information, either stored within the system itself or through online use, without requiring the user to provide any type of information to any outside entity.

The foregoing description has been directed to specific embodiments of this invention. It will be apparent, however, that other variations and modifications may be made to the described embodiments, with the attainment of some or all of their advantages. Therefore, it is the object of the appended claims to cover all such variations and modifications as come within the true spirit and scope of the invention.

What is claimed:

1. A system for providing information to a client computer in a client/server environment comprising a client computer coupled to a server computer, the client computer operable to send demographical information to a server computer and receive a package of rule files from the server computer based on the demographical information, the client computer further operable to select one or more rule files from the package using a rules engine and based on rules clauses-included with the rule files.

2. A method for providing information to a computer in a client/server environment comprising:
sending demographic information to a server computer; receiving a package of rule files from a server computer, the choice of package received determined in part by the demographic information; and
choosing rule files from the package at the client by using a rules-based comparison of demographic information with rules clauses included in the rule files.

3. A computer-readable medium having computer-executable instructions for performing steps comprising:
receiving demographic information; comparing the demographic information received to demographic values stored in one or more rules clauses stored in one or more files stored in a package of files;
selecting files from the package based on the comparison; and
executing actions associated with the selected files.

4. A data structure for a decision engine stored in a computer readable medium, the data structure comprising:
first section for storing actions to be performed; and second section containing one or more rules clauses to be executed by the decision engine, the execution of the actions in the first section depending on the evaluation of the rules clauses.

5. The data structure of claim 4 further comprising a third section containing one or more grammar definitions which define comparison statements for the rules clauses.

6. A rules evaluation system for a user's computer comprising:
a rules-based agent having a plurality of rule clauses for evaluating data;
a plurality of triggers having functionality to notify the rules-based agent to begin evaluating;
a plurality of data providers to provide data for evaluation; and
a plurality of actions for providing information to a user based upon the evaluated data.

7. The rules evaluation system of claim 6, wherein the trigger is based upon user activity.

8. The rules evaluation system of claim 6, wherein the trigger is based upon time.

9. The rules evaluation system of claim 6, wherein the trigger is based upon computer online activity.

10. The rules evaluation system of claim 6, wherein the trigger is based upon hardware present in the computer.

11. The rules evaluation system of claim 6, wherein the trigger is based upon software present in the computer.

12. The rules evaluation system of claim 6, wherein rule clauses can be added dynamically.

13. The rules evaluation system of claim 6, wherein triggers can be added dynamically.

14. The rules evaluation system of claim 6, wherein data providers can be added dynamically.

15. The rules evaluation system of claim 6, wherein actions can be added dynamically.

16. The rules evaluation system of claim 6, wherein the data provider detects a level of ink in the user's printer.

17. The rules evaluation system of claim 6, wherein the data provider detects a speed of the user's computer hard drive.

18. The rules evaluation system of claim 6, wherein the data provider detects an amount of memory installed on the user's computer.

19. The rules evaluation system of claim 6, wherein the data provider detects downloaded software.

20. The rules evaluation system of claim 6, wherein the action is a pop-up box displayed to the user.

21. The rules evaluation system of claim 6, wherein the action is an e-mail sent to the user.

22. The rules evaluation system of claim 6, wherein the action is a link to a related website presented to the user.

23. The rules evaluation system of claim 6, wherein the action is a video displayed on the user's computer.

24. A rules evaluation system comprising:
a rules engine; one or more rules clauses for processing by the rules engine, each rules clause having a specific type, a comparison statement and a value;
a grammar file for processing by the rules engine, the grammar file providing an
interpretation of comparison statements found in the rules clause;
one or more items of user data for processing by the rules engine, the user data containing demographical information concerning a user, the user data to be compared with values stored in the rules clauses by the rules engine; and
wherein the rules engine evaluates the rules clauses using the user data and grammar file, the rules engine executing an action if the rules clauses are evaluated to be true.
